(19) United States
(12) Patent Application Publication
(10) Pub. No.: US 2009/0187435 A1
(43) Pub. Date: Jul. 23, 2009

(54) SECURITY METHODS EMPLOYING DRIVERS LICENSES AND OTHER DOCUMENTS

(76) Inventors: J. Scott Carr, Tualatin, OR (US); Bruce L. Davis, Lake Oswego, OR (US); Stephen K. Decker, Lake Oswego, OR (US); Jonathan L. Hawes, West Linn, OR (US); William C. Hein, III, Glenmoore, PA (US); Kenneth L. Levy, Stevenson, WA (US); John Munday, Concord, MA (US); Burt W. Perry, Lake Oswego, OR (US); Philip Andrew Seder, Portland, OR (US); Joel R. Meyer, Lake Oswego, OR (US); Tyler J. McKinley, West Linn, OR (US); Hugh L. Brunk, Portland, OR (US); Steven W. Stewart, Tualatin, OR (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/352,900

(22) Filed: Jan. 13, 2009

Related U.S. Application Data
(63) Continuation of application No. 10/370,421, filed on Feb. 19, 2003.
(60) Provisional application No. 60/358,321, filed on Feb. 19, 2002.

(51) Int. Cl. G06Q 10/00; G06K 5/00; G06Q 50/00; G06F 17/30

(52) U.S. Cl. 705/5; 235/382; 707/104.1; 707/E17.044

(57) ABSTRACT

Driver's licenses and other security documents include one or more machine-readable features, each conveying plural bits of information. These features are used in a variety of ways to increase security, and/or to enhance functionality. In one embodiment, data encoded on a driver's license is used at airport check-in, to link to a state DMV database and obtain information by which the document, and its custodian, can be authenticated. In like fashion, a license can be used to authenticate a bearer and/or his/her age prior to the sale of alcohol or tobacco products. In other embodiments, different elements of a driver's license (e.g., the substrate, photo, text data, and machine-readable data) are logically bound together (e.g., interlinked through payloads conveyed by different machine-readable features) as a deterrent against counterfeiting. Driver's licenses can be similarly logically bound to personal checks and other documents. Many other arrangements are also disclosed.

### RELATED APPLICATION DATA

This application claims priority from provisional application 60/358,321, filed Feb. 19, 2002.

### TECHNICAL FIELD

The present invention relates to identification documents, such as drivers licenses, and the use of such documents in security applications.

### BACKGROUND AND SUMMARY

Verifying one's true identify is an ever-increasing problem. Identify theft is rampant. Stolen identifies have even been used to facilitate terrorist attacks. And computer networks and secure areas have been breached with misappropriated keys, passwords and codes.

Enhanced security and identification documents are needed. The present disclosure focuses on drivers licenses, but the principles are applicable to any form of identification or smart cards (hereafter regarded as “security documents”).

Techniques for the manufacture of security documents are well known to artisans in the field. Laminated arrangements are often used, with printing formed on the front or back surfaces of some or all of the constituent layers. (The information on certain of these surfaces may require the information be printed using a reverse format.) Materials used may include PET (amorphous polyethylene terephthalate), polycarbonate, polyester, polyurethane, cellulose acetates, polystyrenes, polyvinyl chloride, and polyethylene, together with various paper and synthetic-paper materials (e.g., Teslin). Lenticular lens arrays can be employed, exploiting multiple image information. Exemplary technologies are detailed in U.S. Pat. No. 4,869,946 and in copending application Ser. No. 09/747,735, filed Dec. 22, 2000, and 09/969,200, filed Oct. 2, 2001.

Driver's licenses and other identity documents commonly incorporate machine-readable data, e.g., in the form of a bar code or magnetic stripe. This facilitates error-free reading of the document, e.g., by data terminals in law enforcement vehicles.

Reference is also made to the following patents applications which detail certain technologies useful in security documents:
AN INKJET RECEIVER ON TESLIN SHEET (60/344,685, filed Dec. 24, 2001)
SENSITIZING MATERIALS FOR LASER ENGRAVING (60/344,677, filed Dec. 24, 2001)
FORMING VARIABLE INFORMATION IN IDENTIFICATION DOCUMENTS BY LASER ABLATION (60/344,676, filed Dec. 24, 2001)
LASER ENGRAVING COATING SYSTEM (60/344,675, filed Dec. 24, 2001)
VARIABLE BASED IDENTIFICATION DOCUMENTS WITH SECURITY FEATURES (60/344,686, filed Dec. 24, 2001)
IDENTIFICATION DOCUMENT USING POLASECURE IN DIFFERING COLORS (60/344,687, filed Dec. 24, 2001)
BIOMETRIC IDENTIFICATION SYSTEM (60/344,682, filed Dec. 24, 2001)
MULTIPLE IMAGE FEATURE FOR IDENTIFICATION DOCUMENT (60/344,718, filed Dec. 24, 2001)
MANUFACTURE OF CONTACT-LESS SMART CARDS (60/344,719, filed Dec. 24, 2001)
HEAT ACTIVATED UV CURABLE ADHESIVE COMPOSITION (60/344,688, filed Dec. 24, 2001)
SECURITY INK WITH COHESIVE FAILURE (60/344,698, filed Dec. 24, 2001)
LASER ETCHED SECURITY FEATURE (60/344,716, filed Dec. 24, 2001)
MANUFACTURE. OF CONTACT SMART CARDS (60/344,717, filed Dec. 24, 2001)
MANUFACTURE OF AN ALL-PET IDENTIFICATION DOCUMENT (60/344,673, filed Dec. 24, 2001)
TAMPER EVIDENT COATING TO COMBAT HEAT INTRUSION (60/344,709, filed Dec. 24, 2001)
PRESSURE SENSITIVE UV CURABLE ADHESIVE COMPOSITION (60/344,753, filed Dec. 24, 2001)
FULL COLOR LASER ENGRAVED SYSTEMS FOR IDENTIFICATION CARD IMAGING (60/344,674, filed Dec. 24, 2001)
REDUCING CRACKING IN IDENTIFICATION DOCUMENTS (60/344,710, filed Dec. 24, 2001)
SECURE ID CARD WITH MULTIPLE IMAGES AND METHODS OF MAKING (60/344,683, filed Dec. 24, 2001)
LASER ENGRAVING METHODS AND COMPOSITIONS, AND ARTICLES HAVING LASER ENGRAVING THEREON (10/326,886, filed Dec. 20, 2002)
COVERT VARIABLE INFORMATION ON IDENTIFICATION DOCUMENTS AND METHODS OF MAKING SAME (10/330,032, filed Dec. 24, 2002)
INK WITH COHESIVE FAILURE AND IDENTIFICATION DOCUMENT INCLUDING SAME (10/329,315, filed Dec. 24, 2002)
LASER ETCHED SECURITY FEATURES FOR IDENTIFICATION DOCUMENTS AND METHODS OF MAKING SAME (10/330,033, filed Dec. 24, 2002)
CONTACT SMART CARDS HAVING A DOCUMENT CORE, CONTACTLESS SMART CARDS INCLUDING MULTI-LAYERED STRUCTURE, PET-BASED IDENTIFICATION DOCUMENT, AND METHODS OF MAKING SAME (10/329,318, filed Dec. 23, 2002)
SYSTEMS, COMPOSITIONS, AND METHODS, FOR FULL COLOR LASER ENGRAVING OF ID DOCUMENTS (10/330,034, filed Dec. 24, 2002)
SYSTEM AND METHODS FOR RECOGNITION OF INDIVIDUALS USING COMBINATION OF BIOMETRIC TECHNIQUES (60/418,129, filed Oct. 11, 2002)
IDENTIFICATION CARD PRINTED WITH JET INKS AND SYSTEMS AND METHODS OF MAKING SAME (10/289,962, filed Nov. 6, 2002)
METHODS OF PROVIDING OPTICAL VARIABLE DEVICE FOR IDENTIFICATION DOCUMENTS (60/429,115, filed Nov. 25, 2002)
SYSTEMS AND METHODS FOR MANAGING AND DETECTING FRAUD IN IMAGE DATABASES USED WITH IDENTIFICATION DOCUMENTS (60/429,501, filed Nov. 26, 2002)
MULTIPLE IMAGE SECURITY FEATURES FOR IDENTIFICATION DOCUMENTS AND METHODS OF MAKING SAME (10/325,434, filed Dec. 18, 2002)

Smart cards are available from many vendors, including Gemplus International S.A., ActivCard S.A., PubliCARD, Inc., Atmel, Smart Card Innovators, Inc., Precis, Inc., American Card Technology, among others. Further background for smart cards and smart card readers is provided, e.g., in U.S. Pat. Nos. 5,721,781, 5,955,961, 6,000,607, 6,047,888, 6,193,163, 6,199,144, 6,202,932, 6,244,514, 6,247,644 and 6,257,486.

Many of the arrangements detailed below employ digital watermarking. Digital watermarking is a form of steganography, which encompasses a great variety of techniques by which a plural bit digital data payload is hidden in some other object, without leaving human-apparent evidence of alteration. The hidden payload data can be recovered from the marked object by an automated detection process, e.g., using a web-cam and a personal computer. The payload can convey associated information, or it can provide an index into a data repository where associated information is stored. Basic digital watermark techniques are further detailed in U.S. Pat. No. 6,122,403, and in co-pending application Ser. No. 09/503,881. Watermark techniques useful in security documents are further detailed in U.S. Pat. No. 6,345,104, and in application Ser. Nos. 10/094,593, 10/172,506, 60/418,762 and 60/421,254. “Robust” watermarks are designed to survive initial printing process and further copying via scanning and reprinting. “Frail” (aka “fragile”) watermarks, detailed e.g., in co-pending application Ser. Nos. 09/938,870 (published as US 20020099943) and 09/433,104, are designed to survive initial printing process but not further copying via scanning and reprinting.

### DETAILED DESCRIPTION

State driver license records are computerized, and available on-line to authorized users (e.g., law enforcement, etc.). In accordance with one aspect of the invention, these on-line records are utilized during airport security screenings.

For example, at check-in or at boarding, a passenger may offer a driver's license as a form of identification. An agent can swipe, scan, or otherwise process the card with a terminal unit, to obtain machine-readable data (e.g., steganographic watermark, bar code, mag stripe, RFID, etc.) from the card. This data can then be passed to the corresponding state DMV and used to authenticate the passenger.

In one embodiment, the data is parsed at the airport terminal device to determine the issuing authority (e.g., state of California). The device can determine an electronic address for that authority (e.g., by reference to a local or remote database) and then electronically forward some or all of the machine-read data to the corresponding official data repository (e.g., the California Department of Motor Vehicles). A data server at that facility can check that a driver's license having the machine-read data has been issued by the state, and confirm same to the airport agent. This can be done by a simple OK/Bad message relayed from the state DMV and displayed to the airport agent. Or the state DMV may return a record that includes additional data (e.g., some or all of name, address, birthdate, eye color, hair color, social security number, telephone number, etc.), some or all of which data can be displayed or otherwise communicated to the airport agent. In still other arrangements, the data server may also transmit back to the airport agent a data file containing the photograph that was printed on the originally-issued driver's license, for checking against the photo on the presented driver's license.

If the driver's license is not found to be readable (e.g., no machine-readable data is encoded), the passenger can be investigated further. If the driver's license has machine-readable data, but the corresponding issuing authority has no record of its issuance, the passenger can likewise be further investigated. Ditto if the issuing authority has a record of the license's issuance, but the photo on file with the state DMV does not match that printed on the license.

Subject to privacy and security considerations, data provided from the state DMV may be cached on server at the airport, e.g., for a month. When authenticating passengers, this cache can be checked first. Only if this cache has no data corresponding to a driver's license would the system ping the corresponding issuing authority database for information. Frequent fliers at an airport can thus be authenticated from the cached data—reducing the processing burden on the participating state agencies.

Of course, such an arrangement is subject to numerous variations, e.g., in the data exchanged, the form of verification, etc. If data from several issuing authorities are merged into a common database, then checking would be facilitated since different servers would not need to be queried for different state IDs.

In accordance with another aspect of the invention, renewal of a driver's license can include presenting a soon-to-expire license to a home web-cam. The web-cam generates image data that can be decoded to produce machine-readable data earlier optically encoded thereon (e.g., by watermark or barcode).

In one such embodiment, some or all of the decoded data is transmitted by the user's home computer (to which the web-cam is connected) to a server maintained by the state Department of Motor Vehicles, e.g., using a trusted connection (e.g., a secured sockets connection over the internet). Information normally requested during the renewal process (e.g., updated address data) can be solicited from the user via web page form entry. At the end of the process, the updated folio of information can be transmitted from the DMV's renewal server to a centralized facility for manufacturing of a new driver's license, which can then be mailed to the driver.

A number of variations and enhancements on these basic principles are possible. For example, the user can be instructed to direct and focus the web cam at his/her face, to capture live video of the person seeking renewal. This video can be transmitted to the DMV and checked for visual similarity with the picture earlier on-file for that driver. (The checking can be by a DMV clerk, or by automated facial analysis methods.) If the person's appearance has significantly changed, then a new picture may be required. (For security reasons, the new picture should usually be taken at a DMV office, rather than utilizing the user's home web-cam.) The live video can be archived in a database at the DMV office.

Although not particularly detailed, it is contemplated that an on-line renewal process would include various security checks. For example, to reduce risk of spoofing the live video, the user may be instructed to move in a particular way (e.g., blink three times; hold up two fingers, etc.) to ensure that an earlier-recorded video (or a still photo) is not used. (The instructions can be randomly selected from a set of, e.g., a dozen possibilities; if the user fails to properly respond, promptly, on-line renewal is declined.)

If any of the security checks is failed (e.g., the live video doesn't adequately match the image data in the DMV database; or the live video motion doesn't correspond to instruction, etc.), the person would be instructed to present himself/herself in person at a DMV office for renewal. This fact would be noted in the person's DMV record, so an on-line renewal for that license couldn't be attempted again the next day.

In accordance with yet another aspect of the invention, custody of a driver's license can be used as a form of personal authentication in connection with on-line commerce transactions. For example, the photo on a driver's license may be digitally watermarked with the licensee's name or other uniquely-identifying data. During an on-line transaction, a remote server (e.g., a merchant server) may instruct the user to present his or her driver's license to a home web-cam. Image data from the web cam is transmitted to the remote server, where the watermark is decoded. The decoded data tends to prove physical custody, by the customer, of a driver's license with a given name on it (or with other given data encoded on it). With such proof, the merchant may be more willing to complete certain on-line transactions.

For example, the customer may have earlier filled-out an on-line form giving the name ‘John Doe,’ and specifying a credit card number that the merchant can confirm (through the credit card company) is associated with John Doe. But the merchant doesn't know whether it is, in fact, John Doe who is providing this information, or someone who found John Doe's name and card number in the trash. By demonstrating physical custody of John Doe's driver's license, the customer reduces the merchant's exposure to fraud.

Some credit card issuers may be willing to reduce their merchant fees for transactions verified in this manner. The credit card issuer may pay a fraction of this savings to parties who enabled it, such as the state department of motor vehicles.

Again, this arrangement is subject to numerous variations and enhancements. For example, instead of encoding the licensee's name in the watermark payload, another unique identifier can be used instead. Upon decoding this identifier from the image, the merchant can transmit it to the state DMV, along with the name provided by the customer. The DMV can look-up the identifier, and confirm that it matches the name provided to the merchant. The DMV can then return a ‘match’ or ‘no-match’ assessment to the merchant.

Likewise, instead of transmitting live video to the merchant for decoding, one or a few selected frames can be sent instead. Candidate frames can be analyzed for high frequency image content, and those with the highest such content (suggesting the sharpest images) can be forwarded to the merchant. Or, instead of transmitting image data to the merchant for decoding, this processing can be performed at the user computer instead.

Pending application Ser. Nos. 09/562,049 and 09/790,322 (published as US 20010037313) disclose related fraud deterrent technologies based on proof of card custody, and provide additional details that can be incorporated into such a driver's license-based system.

Related to the foregoing are systems used in retail establishments for performing age authentication, e.g., in connection with liquor and cigarette sales (at restaurants, bars, convenience stores, etc.), car rentals, access to adult content, etc. As is conventional, the purchaser presents a driver's license to demonstrate age. However, instead of relying on a cursory glance by the clerk, the card can be verified using techniques like those disclosed above and below. For example, the customer can show the card to a web-cam associated with a point-of-sale terminal. The web-cam captures optically-encoded data, and the terminal decodes same. If the birthdate is optically encoded on the license, it can be simply displayed to the clerk (or the presenter's current age, as calculated from that birthdate). If another identifier is encoded, it can be transmitted to the corresponding DMV server, which can return a message indicating whether the license belongs to someone above or below a specified age, or returning a picture of the licensed person. Image data from the web-cam (still or video) can be stored—either at the retail establishment or elsewhere (e.g., DMV office) as part of a transaction record.

Photo-swapping and other fraudulent IDs sometimes used in underage liquor/tobacco purchasing can be also discerned using the other techniques detailed in this disclosure.

Eventually, techniques like those detailed herein may enable cigarette and alcohol vending machines to be introduced with such capabilities integrated, permitting machine-sale of age-restricted products with assurances against age-illicit use.

In accordance with still another aspect of the invention, the archival images maintained by state DMV offices may be made available for certain non-DMV purposes. One application is in creating corporate identification badges.

Consider a new employee at her first day of work. At the HR office, the employee presents her driver's license to a web-cam or scanner as part of an interactive new-employee orientation process. An image of the license captured by the web-cam is transmitted to the DMV office, with a request for a corporate ID image. The DMV server decodes a watermark from the image, and optionally checks it against personal information typed-in by the employee. The DMV server then accesses the corresponding driver's license record, and updates same to note the request for a corporate ID image. It then transmits back to the corporate HR department an image file for use on a corporate ID —likely watermarked with data indicating that it was issued by the DMV on <date> to <X> corporation, for corporate ID purposes.

Some of the data watermarked in the image may make the corporate ID suitable for some of the uses to which driver's licenses are typically put (e.g., an encoded identifier may permit the corporate ID to be scanned and certain information about the user to be verified through DMV records).

In accordance with another aspect of the invention, different elements of the driver's license (e.g., the substrate, photo, text data, and machine-readable data) can be logically bound together (interlinked) as a deterrent against counterfeiting. For example, the substrate, photo, demographic data (e.g., text data including), and machine-readable data (e.g., mag stripe or bar code) can be interlinked.

The substrate can be steganographically marked (e.g., by digital watermarking) to encode a substrate identifier. This identifier can be unique (e.g., each card substrate separately serialized), or different batches of cards can share a common identifier (facilitating manufacturing). The watermarking can be effected by any of the techniques known in the art, including fine line printed patterning (e.g., watermarked guilloche), ink spattering, texturing, etc. The watermarking can extend across all of the card, or be localized in certain areas (e.g., the photo and/or the background of the text). (By using a frail watermark, authentication of the substrate stock can be effected.)

The text data (e.g., name, address, date of birth, hair and eye color), can be hashed or otherwise processed to generate a corresponding hash code, digital signature or the like. Ditto the photo.

The machine-readable data on the card (e.g., a watermark, bar code, mag stripe, etc.) can encode the text and photo codes as well as the substrate identifier. (This machine-readable data can be encrypted so as to obstruct unauthorized access.)

In some embodiments, the payload of the watermark can be split to convey two or more codes. These can be respectively, uniquely combined with the photo code and the text code, with the results again stored in the machine-readable data. This yields a card that is multiply-resistant to (1) substitution of the picture; (2) modification of the text data; (3) modification of the machine-readable data; and (4) theft of legitimate substrates.

If each substrate is uniquely encoded, and such encoding is performed after some or all of the photo and text for that card is available, then the photo code and/or the text code can be included in the watermark payload encoded on the card, rather than the watermark payload serving purely to identify the substrate.

In this and the other embodiments disclosed herein, robust and fragile watermarks can be combined on the same card—either in different elements (e.g., robust watermark in photo; fragile watermark in background of text areas), or in overlapping areas (e.g., both forms of watermarks encoded in photo). For example, a frail watermark may encode the batch number of the substrate, together with the state of issuance and the issuing office. The robust watermark may encode the state of issuance and the issuing office (to be checked against the frail watermark data), date of production, etc. The foregoing are all fixed parameters that can be used in encoding large lots of material.

Additionally, or alternatively, individualized information can be encoded (“variable data”), such as driver's license number, date of birth, cross-check data from—or based on—information recorded on mag stripe or bar-code, etc.

The interlinking of data on a driver's license can extend to other documents as well. For example, the checks for a person's checking account can be encoded to steganographically convey the person's driver's license number. Before accepting a check, a merchant may present the document to a reader and confirm that the driver's license number decoded from the check matches that found on that person's driver's license.

Other data can be similarly shared across documents. For example, instead of encoding checks with a driver's license number, they may be encoded with the person's social security number, or date of birth, etc. Or they may be encoded with a hash or digital signature based on such data, or a combination thereof. Documents other than checks can likewise be so-encoded, including credit cards, passports, etc. And driver's licenses can reciprocally be encoded with such data as well.

By such techniques, large collections of documents and things can be tied together. Credit card artwork, photo, or hologram, can include a watermark whose payload matches the watermark payload in the photos of that person's driver's license, passport, and in the background of that person's checks, etc.

Once one of the linked items is validated (e.g., by any of the techniques detailed here, e.g., checking against DMV information), then other documents linked to that item are similarly authenticated. And, as noted, some of these authentication techniques do not rely on external databases, but rely, e.g., on comparison of different data on a card, or between a card and another document, or between a card and the person.

Various hardware systems can perform, or exploit, such authentication (as well as the other methods detailed herein). Examples of such devices include hand-held readers, point of sale devices such as cash register terminals, credit card processing terminals, cash drawers, vending machines, etc.

Consider a related application: A watermark is decoded from a photo ID. That watermark, or the payload it encodes (or a cryptographic permutation of the payload, such as a hash or digital signature) is embedded into a document—such as an airline boarding pass, a visa, a ticket, etc. —issued to the person. Now the photo ID and the issued document are linked through the two watermarks. This enables an additional layer of verification when the bearer presents the photo ID and document to, e.g., gain access, board a plane, etc. In particular, the person has to present the photo ID and document, and the watermarks extracted from those document must match (or otherwise satisfy a predetermined relationship, such as the cryptographic function). Related techniques are disclosed in assignee's U.S. patent application Ser. No. 10/172,506, filed Jun. 14, 2002.

The foregoing illustrates some of the many ways to relate documents and watermarks. In cases involving multiple watermarks, preferably the watermarks are readable by the same detector to simplify implementation. But to prevent someone from merely copying the watermark from the photo ID to some fake document, it is useful to alter the watermark in some way that maintains the relationship between the two documents but does not yield the same watermark.

This concept applies to other forms of printable secure indicia, like some types of bar codes and scrambled indicia. One could likewise apply to other machine readable codes, e.g., mag stripe readers/writers, smart codes, etc.

In one characterization, the concept may be regarded as linking documents together, and also to a bearer/creator, through indicia on a photo ID and only subsequently issued documents. This system for linking documents in a secure fashion also provides a solution for home printing of tickets, boarding passes, and other secure documents (e.g., present photo ID at home print ticket at home, get verified by airport gate agent).

In addition to the foregoing data types, biometric data can be embedded in a driver's license, or shared across several documents. The biometric data can be a fingerprint, a facial feature hash/signature, etc., and it can be encoded in the driver's license photograph, in a state or county logo printed on the card, in the background, or elsewhere, either via a robust or frail watermark. Such data from the card can be verified without reference to a database, by acquiring such data from the user at time of verification.

(Since the parameters describing a face can be lengthy, some embodiments may encode just a few salient facial parameters (such as center location of eye, nose and mouth, or a subset of a full facial hash), e.g., in a watermark. These watermarked features can be combed with a face signature to improve the system's accuracy, since a comparison to another face can be performed with an increased set of features.)

Facial verification as currently practiced is subject to some spoofing. Consider systems that store a hash of the user's face, or some characteristic facial geometry data, in a 2D barcode on the back of a driver's license. A hacker could take his own, valid, driver's license, and replicate the authentic 2D barcode on the back of a counterfeit card bearing a fictitious name or other data. This spoof can be thwarted by the interlinking approaches noted above, e.g., encoding a hash of the barcode data in a watermark formed on the front of the card.

One problem with facial recognition systems is the small set of individuals for which facial data is currently available (e.g., criminal watch lists).

Facial images for driver's licenses are captured under carefully controlled conditions (e.g., exposure, distance, lighting, etc.). Facial fingerprints can be generated from these photos and stored in archives, or encoded with machine readable data on the card (or a hash/digital signature based thereon).

When a person presents the license as a credential, e.g., at an airport, face recognition parameter derived from a camera at the airport can be compared with those on the card for authenticating the person/card.

Moreover, the face parameters on the card can be used as a back-up to the face parameters derived from a camera, to search a watch list or other database. If the person has altered his appearance somewhat to confound recognition of his face, the facial fingerprint stored on the driver's license, or stored remote from the license but linked thereto by an encoded number, can be used to check against the watch list.

Yet another option is to compute a facial fingerprint from an image captured of the photo on the license.

In accordance with another aspect of the invention, the local watermark intensity (signal strength) across a driver's license (or other document) can be measured, (and, if desired, pro-actively set). A hash of this intensity map can then be used to characterize the license (or the photo thereon), giving a tunable “fingerprint” of the license (or photo). This hash can then be encoded on the card with other machine-readable data.

(Techniques for measuring watermark intensity across a document are disclosed, e.g., in U.S. Pat. No. 6,122,403, and in pending application Ser. Nos. 09/689,226 and 09/938,870.)

While the disclosure, so far, has focused on machine-encoded data on one or both of the driver license's faces, applications are also served by encoding the edges.

A driver's license is about one millimeter thick. Using printing or laser engraving, data be encoded around the entire edge of the card (either using watermark technology, bar-codes, or other encoding techniques).

Laser engraving may increase the durability of the marking, since it actually creates physical voids, or pels, that have a long lifetime. These voids may be filled with ink, or not.

Marking around all four sides is not, of course, essential. However, it may facilitate usability (e.g., the four sides could each convey the same payload, permitting whichever side is handiest to be read), or extend the payload that may be encoded.

The marking could be detected by a swipe-like device, of the sort used to read mag stripe cards. Indeed, the functionality may be integrated into mag stripe readers. A single LED/photodetector could illuminate and sense the edge marking as the card is swiped. A single swipe permits both mag stripe data, and the peripherally encoded data, to be captured.

On advantage of such an arrangement is the difficulty of counterfeiting. Consumer-available printing technologies are not well suited to replicate such markings. Since the markings may be fashioned with a density of, e.g., 300 voids per inch, hand-counterfeiting is not practical.

The data encoded along the edge of the card encompasses all of the data discussed herein for encoding in a watermark or on a mag stripe. And, as described above, information recorded in this manner can be logically linked with information recorded elsewhere on the card, or remote from the card, to authenticate same.

(An exemplary card may encode two fields—one an identifier corresponding to the state of issuance, and the second an identifier corresponding to the particular issuing station within that state.)

In some applications, a watermarked security document can be presented in dynamic fashion to a sensor to affect an authentication, unlocking, or other operation. This is useful, e.g., in reducing man-in-the-middle attacks on security.

For example, a driver's license may be encoded with different watermarks on the front and back sides. The person may be instructed to present each side in a specific, but random, order to a sensor, e.g., front, back, front, front, back. Or the document can be used in other gestural movements to define other unique combinations required to authorize certain operations. (Gestural input via watermarks is further detailed in application Ser. No. 09/571,422.)

Yet another concept its to apply a watermarked sticker to a security document, so that watermarks from both the document and sticker are read when the document is presented to a sensor. The sticker may be updated periodically (e.g., by removing/replacing with a new sticker, or simply attaching the new sticker over the old one). New stickers can be distributed on a periodic basis, or sporadically dependent on the context. The stickers may be printed by the user, or provided from a third party.

In some applications, it is desirable—e.g., for anonymity—to encode less information rather than more in machine-readable data. For example, a driver's license might encode only the bearer's date of birth. This credential would be sufficient for utilizing the privileges, goods, and services associated with adults, without surrendering additional information that is not needed for such applications.

Reference was made, above, to deriving a “hash” code, or digital signature, corresponding to certain data (e.g., photo image, facial pattern, driver license number and other text data printed on card, etc), and encode that code on the document. A related concept makes a different use of the code. The code can be used as spreading key, or noise signal carrier, by which a watermark payload is randomized and dispersed for encoding. Thus, for example, all of the text fields on a driver's license may be hashed, and the resulting value used as the spreading key by which any item or items of data (e.g., name, birthdate, DL number, etc.) is/are encoded into the driver's license photo (or background, or edge, etc.). The approach offers good security, since changing any single character of the printed text on which the hash is based would make the watermark unreadable. (A reader device could acquire the necessary text data from the printed card, e.g., by OCR techniques. Or, if the text data is replicated in mag stripe- or barcode-recorded data, it could be used instead.)

Variations include combinations with other watermarks. A single robust grid could be employed with two robust messages, one with a known (fixed) spreading key, and the other with a spreading key derived from the card text. Thus, the first message could be read regardless of text on the card, and the second message could only be read if the text is found in its unaltered state. (The “grid” is a reference a subliminal graticule signal used to discern scale and/or rotation of the scan data, as further detailed in U.S. Pat. No. 5,832,119, and in application Ser. No. 09/503,881.)

A variant on this approach is for the spreading key for the second message to be encoded in, or indexed by, the first message payload. That is, the first message could be read, and the payload used to query a database for the spreading key to be used in reading the second message.

Again, this concept can be used in conjunction with the embodiments concerning logical interlinking of disparate data/documents detailed above.

It may be recognized that commonly available image morphing software poses a threat to some photo ID systems. Scanning and morphing the original face on an ID with the face of an imposter (counterfeiter) could provide a hybrid image that looks sufficiently like both the imposter and the original photo to fool both human and machine recognition/inspection systems. Such ruses are addressed by various of the approaches described above, e.g., evidencing tampering with the photograph by the absence, or disruption, of an image watermark.

ID cards can also be used in safeguarding a user's private (e.g., biometric) information. For example, in the above-cited patent application No. 60/344,682 titled “Biometric Identification System,” filed Dec. 24, 2001, there is disclosed a biometric system for controlling access, verifying identity, etc. The system is based on the premise that an information carrier (e.g., a smart card) carries a user's biometric information, instead of storing biometric data in a central (and perhaps public or governmental) database. The user retains control over the card. Hence access to the user's biometric data is closely regulated.

There are alternative methods for safeguarding a user's biometric information, particularly if the biometric data is stored in a central or governmental location. For example, an identification card may include an embedded digital watermark having a payload. The payload includes an index which is used to interrogate a biometric database. The user's biometric data is stored in the database in an anonymous manner. In other words the only database user identification is the index and not the user's social security number, name and address. Access to the database is authorized by the user presenting the ID document for sampling. Privacy is enhanced by encrypting the index and/or by combining the index with user input such as a PIN/password.

Further, consider an embedded digital watermark payload that includes a hash or other reduced-bit representation of a user's biometric data. For example, a retinal scan is reduced to a 32-256 bit hash. Or a user's thumbprint is processed to produce a hash. Still further, a DNA sample (or voice print, face recognition map, etc., etc.) can be represented by a hash or other reduced bit representation. The hash is included in the digital watermark payload (a “stored hash”). To verify identity, a biometric sample, e.g., a thumbprint, is taken from the user. The same (or complimentary) hashing algorithm is preformed on the biometric sample to produce a hash (a “sampled hash”). The payload is decoded from the embedded ID document to retrieve the stored hash. The stored hash is compare with the sampled hash to determine/verify identity. A user thereby retains control of her biometric data, without having to store the data in a centralized location. (The ID document preferably includes a fragile digital watermark to help prevent document tampering).

The techniques disclosed herein also can be applied to the looming problems associated with authenticating voter credentials—either at voting sites, or in connection with on-line voting systems.

Driver's licenses or other identification documents may also be used in conjunction with automobile control. Consider a driver's license that is embedded with a digital watermark. The watermark carries a code to enable or start an automobile. (Of course the automobile is equipped with a digital watermark reader, e.g., an optical sensor and watermark detecting/decoding software for execution on processing circuitry. Or the watermark reader is included in a cell phone, PDA, laptop, etc., which is in communication with the automobile or an automobile security device). In order to start the car, the driver must first present her driver's license to the reader. The reader extracts the code and compares the code with an “authorized driver” code list. If the extracted code is on the list, the car is enabled and allowed to start. (This may be analogous to cars that are equipped with “breathalyzers”—to check the driver's blood-alcohol level prior to allowing the car to start.)

The authorized driver code list can be configured to accept multiple codes, e.g., to accommodate a family having several drivers. Or to allow an employee to drive a company car. The list can be similarly modified to prevent a teenager from driving a car while his parents are away on the weekend. Or the list can be configured to allow a class of people (e.g., all those with valid driver's licenses) to start the car.

The code may also include an age, driving level and/or expiration identifier. Many states require young drivers (e.g., those with “learning permits”) to be accompanied by a licensed adult. The learning permit preferably carries a watermark code that conveys to the watermark reader that an adult must be present. Accordingly, the car will not start unless the licensed adult presents her watermarked license. Or if a state has driving restrictions based on age or disability (e.g., a rule that a 15 year old or a person with night blindness cannot drive at night), a watermark code can convey such restrictions. An expiration identifier will help ensure that a driver with an expired license is unable to start their car. (The driver may optionally obtain an “emergency” card, to be stored in the car's first aid kit, to allow a one-time only use of the car, in the event that a license is lost or stolen and a medical emergency exists. Once the emergency card identifier is used, it can not be used with that car again).

Among the advantages of such an arrangement is that it may deter car theft, since a thief must have an authorized driver's license to start the car.

To the extent not already clear, it should be re-iterated that fragile watermarking can be used for some or all of the watermarking applications noted herein.

It will be appreciated by those of ordinary skill in the art that several print technologies, including but not limited to laser xerography, offset printing, inkjet printing, or dye diffusion thermal transfer, can be used to print on the driver's license (or the surface layers of laminates thereof), either in CYMK or using spot color. Laser marking can also be used. See, e.g., the earlier referenced applications, together with U.S. Pat. Nos. 6,022,905, 5,298,922, 5,294,774, 4,652,722, 5,824,715 and 5,633,119.

As the functionality associated with drivers' licenses extends from strict law enforcement applications into business applications, it may be appropriate for the business beneficiaries to help pay for such functionality extensions. In some instances, such as the on-line commerce example, above, the merchants or credit card issuers may pay a fee to the participating DMVs. In others, it may be appropriate to charge an extra fee to the users who reap a benefit.

To provide a comprehensive disclosure without unduly lengthening the specification, applicants herein incorporate by reference each of the patents and patent applications referenced above.

The particular combinations of elements and features in the above-detailed embodiments are exemplary only; the interchanging, substitution, and combination of these teachings with other teachings in this and the incorporated-by-reference patents/applications are also expressly contemplated.

For example, while the foregoing disclosure focused on watermark-based techniques, the same benefits may also be achieved through use of other technologies, such as bar codes (1D or 2D), mag stripe, RFID chips, scrambled indicia, etc. Photonically active materials can also be used to encode plural-bit machine-readable identifiers in media, as detailed in U.S. Pat. Nos. 5,903,340, 6,441,380, and in publication US20020105654.

Likewise, techniques detailed in connection with driver's licenses also find application in connection with other documents, and many electronic objects.

The decoding of watermark data can often be done at several different locations, e.g., at the computer to which a web-cam is connected, at a remote server that participates in the process, etc. The location of such watermark decoding is generally not critical to the principles of the illustrative embodiments, and can be determined based on factors such as security considerations, processing burdens, etc.

While reference was repeatedly made to web-cams, this is but one of several possible optical reading devices. Others can naturally be used, including cameras and scanners (both 1D and 2D).

While described in the context of security documents, it will be recognized that the principles described herein are not so limited can be applied to any documents, and more generally may be applied to non-printed items, such as audio, image, and video data—context permitting.

1-17. (canceled)

18. An authentication method, said method being performed by execution of computer readable program code by a processor of a first computer system, said method comprising:
reading machine-readable data from a driver's license of a person checking in for air travel;
determining based on the read data identity of a governmental authority that issued the license;
forwarding at least some of the read data to a second computer system having access to data records compiled by said governmental authority and relating to said license;
receiving back from said second computer system a data message generated by the second computer system based, at least in part, on the at least some of the read data forwarded by the first computer system, the data message including data retrieved from the data records of said governmental authority relating the person; and
processing the received data message to determine if the data of the data message matches the data on the driver's license.

19. The method of claim 18, wherein the data message generated by the second computer system includes data relating to some or all of:
name of the person to whom the license was issued;
address of the person to whom the license was issued;
birth date of the person to whom the license was issued;
hair color of the person to whom the license was issued;
eye color of the person to whom the license was issued;
a telephone number associated with the person to whom the license was issued; and
a copy of the photograph that appears on the license.

20. The method of claim 18 wherein the data message includes data indicative of whether the data on the driver's license is valid.

21. The method of claim 20 wherein the data indicative of whether the data on the driver's license is valid include one of: an “OK” notification and a “Bad” notification.

22. The method of claim 18 further comprising:
accessing, prior to the forwarding of the at least some of the read data to the second computer system, a cache memory device locally coupled to the first computer system to perform a determination of whether the data retrieved from the data records of said governmental authority relating to the person was previously stored on the cache memory device; and
based on the determination, performing one of:
retrieving the data relating to the person from the cache memory device if the data retrieved from the data records of said governmental authority relating the person was previously stored on the cache memory device, and
if the data relating to the person based on the data records of said governmental authority is not stored on the cache memory device, performing the forwarding of the at least some of the read data, and upon receipt of the data included in the data message received from the second computer system, storing on the cache memory device the data received from the second computer system.

23. The method of claim 18 wherein processing the received data message comprises:
performing a comparison of the data of the received data message and the data available from the driver's license.

24. The method of claim 18 wherein reading the machine-readable data from the driver's license of the person comprises:
reading the driver's license data encoded in one or more of: a steganographic watermark, a bar code, magnetic strip and RFID.

25. An authentication system comprising:
a reading apparatus to read machine-readable data from a driver's license of a person checking in for air travel;
a first processor-based computing apparatus coupled to the reading apparatus and configured to receive the read data; and
a storage device coupled to the first computing apparatus, the storage device storing computer instructions that, when executed on the first processor-based computing apparatus, cause the first computing apparatus to:
determine, based on the read data from the driver's license, identity of a governmental authority that issued the license;
forward at least some of the read data to a second computing apparatus having access to data records compiled by said governmental authority relating to said license;
receive back from said second computing apparatus a data message generated by the second computing apparatus based, at least in part, on the at least some of the read data forwarded by the first computing apparatus, the generated data message including data retrieved from the data records of said governmental authority relating to the person; and
processing the received data message to determine if the data of the data message matches the data on the driver's license.

26. The system of claim 25, wherein the data message generated by the second computing apparatus includes data relating to some or all of:
name of the person to whom the license was issued;
address of the person to whom the license was issued;
birth date of the person to whom the license was issued;
hair color of the person to whom the license was issued;
eye color of the person to whom the license was issued;
a telephone number associated with the person to whom the license was issued; and
a copy of the photograph that appears on the license.

27. The system of claim 25 further comprising:
a cache memory device locally coupled to the first computing apparatus;
wherein the computer instructions stored on the storage device of the first computing apparatus further comprise instructions that, when executed on the first processor-based computing apparatus, further cause the first computing apparatus to:
access, prior to the forward of the at least some of the read data to the second computing apparatus, the cache memory device to perform a determination of whether the data retrieved from the data records of said governmental authority relating to the person was previously stored on the cache memory device; and
based on the determination, perform one of:
retrieve the data relating to the person from the cache memory device if the data retrieved from the data records of said governmental authority relating the person was previously stored on the cache memory device, and
if the data relating to the person based on the data records of said governmental authority is not stored on the cache memory device, perform the forward of the at least some of the read data, and upon receipt of the data included in the data message received from the second computing apparatus, store on the cache memory device the data received from the second computing apparatus.

28. A computer program product residing on a computer readable medium and comprising computer instructions that, when executed on a first processor-based computing apparatus, cause the first computing apparatus to:
read machine-readable data from a driver's license of a person checking in for air travel;
determine, based on the read data, identity of a governmental authority that issued the license;
forward at least some of the read data to a second computing apparatus having access to data records compiled by said governmental authority and relating to said license;
receive back from said second computing apparatus a data message generated by the second computing apparatus based, at least in part, on the at least some of the read data forwarded by the first computing apparatus, the generated data message including data retrieved from the data records of said governmental authority relating to the person; and
processing the received data message to determine if the data of the data message matches the data on the driver's license.

29. The computer program product of claim 28, wherein the data message generated by the second computing apparatus includes data relating to some or all of:
name of the person to whom the license was issued;
address of the person to whom the license was issued;
birth date of the person to whom the license was issued;
hair color of the person to whom the license was issued;
eye color of the person to whom the license was issued;
a telephone number associated with the person to whom the license was issued; and
a copy of the photograph that appears on the license.

30. The computer program product of claim 28 wherein the computer instructions further comprise instructions that, when executed on the processor-based computing apparatus, further cause the first computing apparatus to:
access, prior to the forward of the at least some of the read data to the second computing apparatus, a cache memory device locally coupled to the first computing apparatus to perform a determination of whether the data retrieved from the data records of said governmental authority relating to the person was previously stored on the cache memory device; and
based on the determination, perform one of:
retrieve the data relating to the person from the cache memory device if the data retrieved from the data records of said governmental authority relating the person was previously stored on the cache memory device, and
if the data relating to the person based on the data records of said governmental authority is not stored on the cache memory device, perform the forward of the at least some of the read data, and upon receipt of the data included in the data message received from second computing apparatus, store on the cache memory device the data received from the second computing apparatus.
